(19) United States
(12) Patent Application Publication
(10) Pub. No.: US 2006/0138185 A1
(43) Pub. Date: Jun. 29, 2006

(54) Single-piece instantly detachable locking device with a board for traveling bag on bicycle carrier

(76) Inventors: Chien-Ping Lien, Shu-Lin City (TW); Kuo-Ping Ho, Taipei City (TW)

Correspondence Address: LEONG C LEI, PMB # 1008, 1867 YGNACIO VALLEY ROAD, WALNUT CREEK, CA, 94598, US

(21) Appl. No.: 11/020,147

(22) Filed: Dec. 27, 2004

(51) Int. Cl. B62J 9/00

(52) U.S. Cl. 224/427; 224/437; 224/452

(57) ABSTRACT

A single-piece instantly detachable locking device for a bicycle carrier is composed of a base board, and a mobile hook installed at the base board. The top surface of base board is fastened to the bottom surface of the loaded piece, such as a traveling bag, basket or box, via screws or nails, while the bottom surface of the base board leans against the top surface of the bicycle carrier. More than one fixed hook are downwardly provided at one side of the base board, whereas a mobile hook is provided at the other side, such that the aforesaid hooks can be combined to the two sides of the bicycle carrier and locked to the bottom side thereof. Accordingly, the locking device can allow a loaded piece be easily fastened to the bicycle carrier, and can be instantly detached when it is not in use.

### BACKGROUND OF THE INVENTION

(a) Technical Field of the Invention

The present invention relates to a single-piece instantly detachable locking device with a board for traveling bag on a bicycle carrier, which is particularly adapted to a bicycle carrier for combination with all kinds of loaded pieces, such as traveling bags, baskets and boxes, and can be instantly installed and detached.

(b) Description of the Prior Art

Bicycles have been extensively used in traffic, sports and outdoor activities, etc. However, as the bicycle is simple-structured, it is usually wanted a space for carrying goods. For such purpose, people always disposed a traveling bag on the carrier. In conventional locking devices that can be easily installed and detached, the inventor's prior U.S. Pat. No. 6,607,327 entitled “A fastening device for the backseat of a bicycle” is primarily composed of an actuatable fastener, which is collocated with a fastening device for the loaded piece on the bicycle carrier to accomplish an instantly detachable fastening device. While the bottom of the located piece is provided with a peg, which can be coincidentally engaged into the corresponding peg slot on the base of the bicycle carrier, the peg is pulled toward the locking flap at the rear of the peg slot such that the peg slot is in alignment with the corresponding locking flap, thereby the flap of the actuatable fastener will be automatically fastened to a dismantling rod of the bicycle carrier. Although said structure can improve the disadvantage of hard installation and detach existing in the prior art, the fastening device should be applied to some specific bicycle carriers and fastening devices for loaded piece.

As bicycle used nowadays has a board in the carrier, the way of fastening a traveling bag to the bicycle carrier is not applicable to the present bicycles. The inventor thus researched and disclosed the present invention for improvement purpose.

### SUMMARY OF THE INVENTION

The primary purpose of the present invention is to provide an instantly detachable locking device with a board for easily locking all kinds of loaded piece to a bicycle carrier.

To obtain the above object, the invention is composed of a base board and a mobile hook installed at the base board. The base board has a size adapted to the width of the bicycle carrier. The top surface of the base board is combined with the bottom surface of a loaded piece, such as traveling bag, basket or box, via screws or nails, while the bottom surface of the base board leans against the top surface of the bicycle carrier. A fixed hook is downwardly provided at one side of the base board, whereas a mobile hook is provided at the other side, such that the aforesaid hooks can be locked and combined to the left and right sides of the bicycle carrier. Accordingly, the locking device can allow a loaded piece be easily fastened to the bicycle carrier, and can be instantly detached when it is not in use.

To completely appreciate these and other objects of the present invention as well as the invention itself, all of which will become apparent to those skilled in the art, the following detailed description of the invention and the claims should be read in conjunction with the accompanying drawings.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is an exploded view of the present invention.

FIG. 2 is a perspective view of the present invention after being assembled.

FIG. 3 is a bottom view of the invention after being assembled.

FIG. 4 shows combination of the invention to a traveling bag.

FIG. 5 shows combination of the invention to a bicycle carrier.

FIG. 6 is a cut-away view showing combination of the invention to a bicycle carrier.

FIG. 7 shows application of an embodiment of the invention.

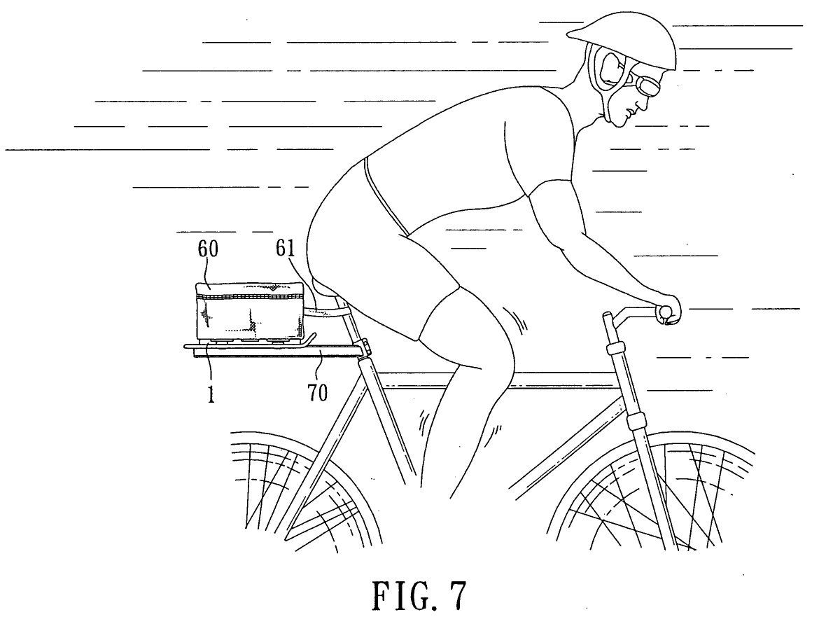

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

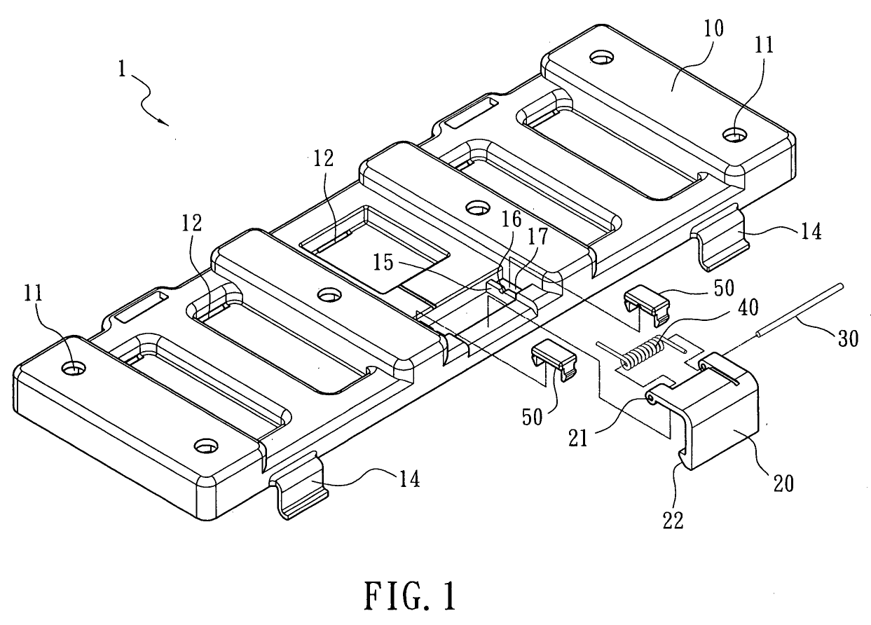

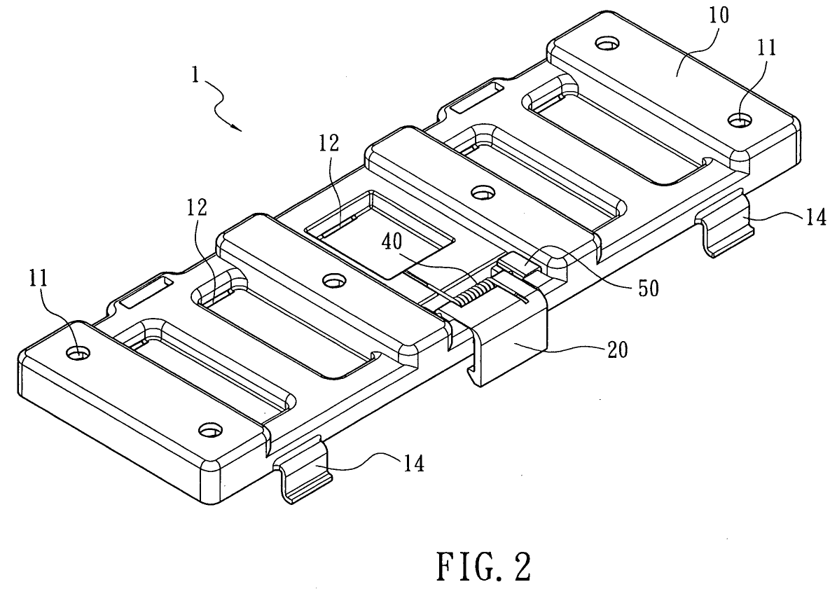

Referring to FIGS. 1 to 4, the invention relates to a single-piece instantly detachable locking device 1 for mounting on a bicycle carrier, which is composed of a base board 10, and a mobile hook 20 provided at the base board 10.

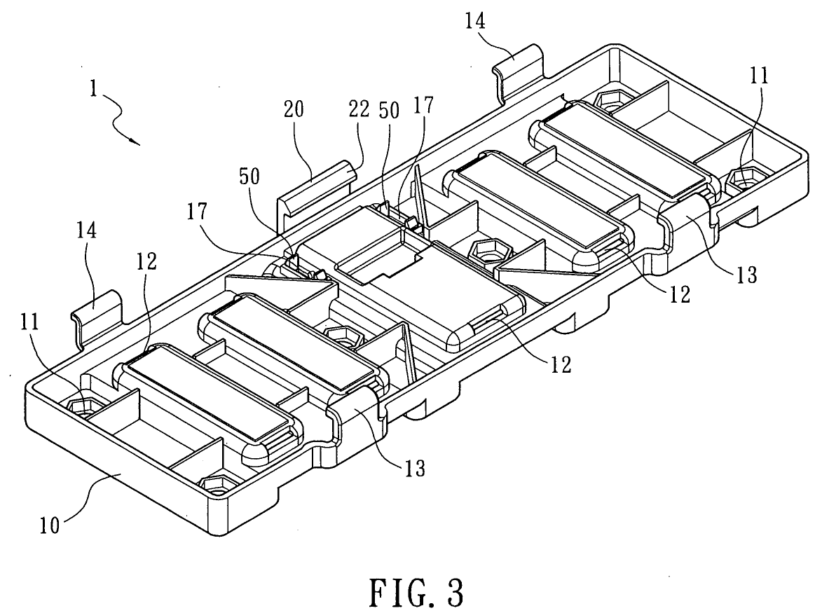

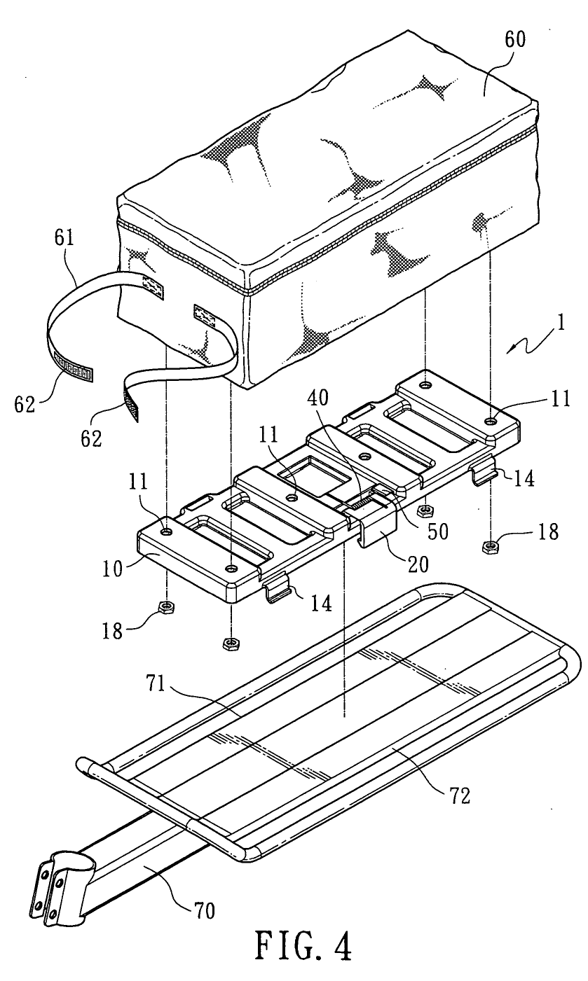

The base board 10 has a size adapted to the distance between the left rack 71 and the right rack 72 of the bicycle carrier 70. The top surface of the base board 10 has pluralities of through holes 11 for combination with a traveling bag 60 (i.e. loaded piece) via screws or nails (as shown in FIG. 4). Besides, pluralities of water outlets 12 are provided inside of the grooves 16. While the base board 10 is downwardly provided with pluralities of fixed hooks 13 at one side (as shown in FIG. 3), pluralities of supporting flaps 14 are downwardly provided at the other side for cooperation with the fixed hooks 13 to serve as the feet for supporting the traveling bag 60 when it is put on the ground. Furthermore, two supporting ribs 15 are provided at the side of the base board 10 where the supporting flaps 15 are, while each of the supporting ribs 15 has a notch 17 at the outer side.

The mobile hook 20 is in form of a downwardly bending flap, which is provided with two dowel holes 21 at one end, and a hook having an inclined plane 22 bottom at the other end.

When assembling the aforesaid elements, a dowel 30 goes through the dowel holes 21 and a spring 40 with the two ends thereof disposed inside of the grooves 16 of the base board 10. Meanwhile, the two ends of the spring 40 extend to lean against the top surfaces of the base board 10 and the mobile hook 20, respectively, such that the pressure flaps 50 can press and lock into the notches 17 with their feet hook into the bottom of the notches 17, thereby pressing and locking the dowel 30.

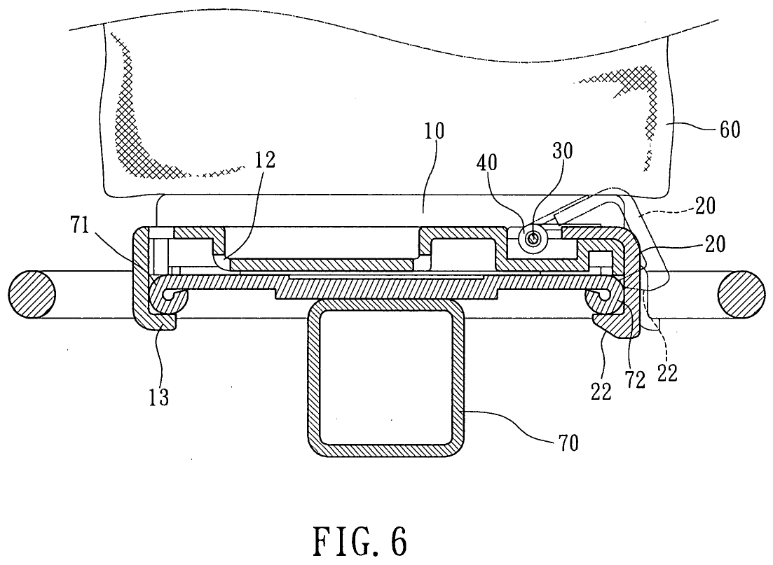

As shown in FIGS. 4 and 6, taking a traveling bag 60 as an example, when installing the loaded piece onto the bicycle carrier, the user must combine the bottom surface of the traveling bag 60 with the top surface of the single-piece instantly detachable locking device 1 via screws or nails. As shown in FIG. 4, the bolts (not shown) go out of the traveling bag 60 from the inside through the through holes 11 of the base board 10, and then are firmly fastened and combined to the bottom of the base board 10 via screw nuts 18.

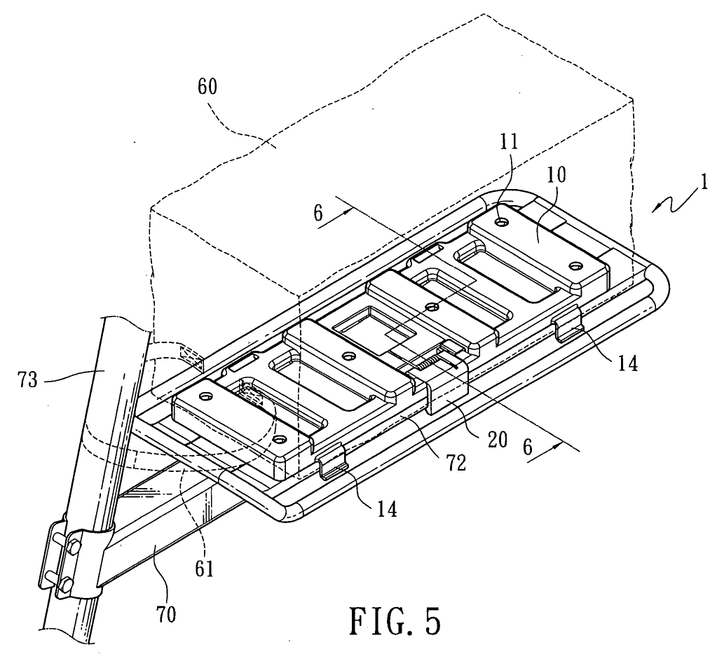

As afore-mentioned, when combining the traveling bag 60 with the bicycle carrier 70, the user must firstly hook the fixed hooks 13 at one side of the single-piece instantly detachable locking device 1 to the edge of the left rack 71 (as shown in FIG. 6), and then press the mobile hook 20 downwardly to make the inclined plane 22 bottom of the mobile hook 20 to slide into the right rack 72, thereby the mobile hook 20, which is resilient, will expand outwardly and firmly lock with the right rack 72. Furthermore, holding strips 61 may be provided at the front end of the traveling bag 60. By way of sewing magic tapes 62 (Velcro) onto the holding strips 61, the traveling bag 60 can be held on the seat post 73 (as shown in FIG. 5), such that when the bicycle is in progression, the traveling bag 60 would not move back and froth, instead, it can be firmly held. When removing the traveling bag 60 from the bicycle carrier 70, the use needs only pull open the mobile hook 20 via his/her finger, the mobile hook 20 will easily detach from the right rack 72.

Concluded above, the single-piece instantly detachable locking device according to the invention is a simple constructed locking device, which can permit firm combination of the loaded piece and the bicycle carrier. The user can have the loaded piece instantly fastened to or detached from the bicycle carrier simply by pressing or pulling open the mobile hook.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A single-piece instantly detachable locking device with a board for traveling bag on a bicycle carrier, including a base board and a mobile hook installed on the base board, characterized in that:
the base board has a size adapted to the distance between the left and right sides of a bicycle carrier; one side of the base board is provided with a mobile hook, while the other side is provided with a fixed hook; the top surface of the base board is connected with the bottom surface of the loaded piece; the mobile hook is in form of a downwardly bending flap, which is provided with two dowel holes at one end, and a hook having an inclined plane bottom at the other end; a dowel goes through the dowel holes at the mobile hook and a spring so as to be fastened to the base board.

2. The single-piece instantly detachable locking device with a board for traveling bag on a bicycle carrier according to claim 1, wherein the base board is provided at the side where the mobile hook is provided more than one supporting flap to serve along with the fixed hooks as the feet of the traveling bag.

3. The single-piece instantly detachable locking device with a board for traveling bag on a bicycle carrier according to claim 1, wherein the mobile hook is combined with the base board via a dowel going through the dowel holes at the hook and a spring; the two ends of the dowel are then inserted into the grooves at the base board, such that the two extending ends of the spring lean against the top surfaces of the base board and the mobile hook, respectively; by way of pressing the pressure flaps to lock into the notches on the base board, the dowel is locked and combined to the base board.

4. The single-piece instantly detachable locking device with a board for traveling bag on a bicycle carrier according to claim 1, wherein the loaded piece can be in form of a bag, basket or box for containing articles.

5. The single-piece instantly detachable locking device with a board for traveling bag on a bicycle carrier according to claim 1, wherein the grooves on top surface of the base board are provided with water outlets.
